(19) United States
(12) Patent Application Publication
(10) Pub. No.: US 2002/0180591 A1
(43) Pub. Date: Dec. 5, 2002

(54) Programable pet care reminder timer

(76) Inventors: Edward Alan Berstling, Sarasota, FL (US); Charles Edmund Murphy, Sarasota, FL (US)

Correspondence Address: EDWARD A. BERSTLING, 326 AVENIDA MILANO, SARASOTA, FL, 34242, US

(21) Appl. No.: 09/849,567

(22) Filed: May 4, 2001

(51) Int. Cl. G08B 1/00

(52) U.S. Cl. 340/309.15; 340/573.3; 340/693.5; 340/693.9

(57) ABSTRACT

A small self contained programmable reminder timer having an attachment means (16) by which the device can be attached to items within a household or attached to a pet's collar or cage (28). Audio (18) and visual (12) indicators alert a pet owner when to administer grooming, exercise, feedings, and other routine or special pet care maintenance requirements. The timer and associated electronic circuitry is packaged in a decorative housing (10) that provides the pet owner the ability to visually distinguish the type of pet the timer is to be used for.

### BACKGROUND

1. Field of Invention

This invention relates to programmable electronic timer devices, specifically to those that can be affixed to common objects and programmed to remind pet owners when to administer grooming, exercise, medications, feedings, and other routine or special pet care maintenance requirements.

2. Description of Prior Art

Owners of pets frequently must administer scheduled care, feedings, grooming, exercise and medications, etc., to ensure their pet is kept healthy and well maintained. Presently, the pet owner may use a memorization method to recall these events, or they use a wall or desk calendar to write down and schedule these events. Some manufacturers of pet care products have enhanced the calendar method by providing colorful adhesive reminder labels that the pet owner can apply to specific dates on the calendar.

Although not specifically designed for pet care applications, other inventors have proposed electronic reminder devices. U.S. Pat. No. 5,554,967 to Cook, Weitzel, and Hawley (1984) discloses a reminder device in a credit card size packaging, designed to be carried in a wallet or purse and to specifically remind humans when to take medications. U.S. Pat. No. 4,588,303 to Wirtschafter and Walton (1984) describes a medical timer apparatus that specifically attaches to and is used with a medication container or pill bottle. Our invention describes an electronic reminder device specifically designed for pet owners, to ensure all pet care needs are administered, but nevertheless, memorization methods, calendar methods and the present available electronic reminder devices mentioned, have several drawbacks and suffer from a number of disadvantages:

(a) When a pet owner uses the memorization method, many times they forget to administer the pet's care needs due to other important daily or business related responsibilities. This method can also be very challenging, if not impossible for the elderly or those that are mentally challenged.

(b) If the pet owner uses the calendar method to schedule and administer pet care, several disadvantages are presented. The calendar requires the pet owner to write down the event in the calendar. No automatic reminder is provided. It is up to the pet owner to review the calendar on their own initiative. Again, this method can be challenging for elderly pet owners, and anyone who may be mentally or physically impaired. Even with younger pet owners, a calendar method may not be effective because of busy work schedules and lifestyles.

(c) If the pet owner uses a single calendar to schedule daily household, social events and pet care related events, there is a very limited area in which to write down events that occur on the same day. The limited area to for scheduling these multiple events is especially compounded when the pet owner uses one or more of the colorful adhesive reminder labels that are supplied with some pet manufacturer's products.

(d) The calendar method also had disadvantages because of its large physical size. Often a pet owner will place the calendar in an hidden or not easily accessible location, therefore making it more troublesome to find and review the calendar on a regular basis.

(e) The present electronic reminder devices are specifically designed to facilitate and support a human's medical care needs. They are not designed or programmable to facilitate a pet's care needs.

(f) The present electronic reminder devices are complicated to operate and program. Many include a complex keypad or plurality of switches that the user must program to schedule the alarm event.

(g) Electronic reminders available today are designed to be carried in a hidden or not easily accessible location, such as a wallet, purse or pocket. When concealed in these areas, audible alarms may not be heard and visual alarms cannot be seen.

(h) The electronic medication reminders for humans are not designed to facilitate each different type of pets needs. For example, a dog, cat or bird each may need to have specific reminders to indicate the type of care the pet requires, such as bathing, ointments, grooming, exercise, feedings, etc.

(i) The electronic reminders have no means of attaching it to an object that provides an easily and readily accessible location where it can easily be found.

(j) The present electronic timers are packaged in a unattractive housing and are not pleasing aesthetic to view when they are placed in a hidden or not easily accessible location.

(k) The present electronic timers for provide a monotone alarm enunciator that may not easily be heard or is distinguishable to the user.

### SUMMARY

In accordance with the present invention a small programmable pet care reminder timer that can be placed in a easily and readily accessible location to provide automatic audible or visual reminders to the pet owner so that they may administer a pet's care needs.

Objects and Advantages

Accordingly, besides the objects and advantages of the programmable pet care reminder timer described in our above patent, several objects and advantages of the present invention are:

(a) to provide a convenient method to help a pet owner determine when to administer a pet's needs and care without having to memorize dates and times;

(b) to eliminate the use of a wall or desk calendar to schedule and review when to administer the pet's needs and care;

(c) to eliminate having to maintain multiple calendars and to save the limited writing space in a single calendar when the users is scheduling pet related and non-pet related events;

(d) to provide a small electronic reminder device that can be placed in an easily and readily accessible location for the pet owner to see or hear its alarm reminders;

(e) to provide an electronic reminder timer with audible or visual alarms that will identify when to administer specific grooming, feeding, exercise and medications, etc. for a type of pet;

(f) to provide an automatic reminder that alerts the pet owner with audible or visual alarms that can indicate specific pet care needs for one or a plurality of different types of pets;

(g) to provide an electronic reminder device for pet maintenance that is simple and convenient to operate, thus eliminating the use of complicated keypads or a plurality of switch setting arrays;

(h) to provide an electronic reminder device for pet owners where its audible or visual alarms are not concealed and are readily accessible to the pet owner;

(i) to provide an electronic reminder device for pet owners that the type of maintenance care required for the pet can be customized for a specific type of pet;

(j) to provide an electronic reminder timer for pet owners that incorporates an attachment means to allow the pet owner to place the invention in an easily and readily accessible location where it can be used;

(k) to provide a electronic timer for pets that is decoratively packaged using themes that correlate to the type of pet and is aesthetically pleasing to view when the invention is placed in view and in a readily accessible location;

(l) to provide a electronic timer for pet owners that can provide novel audible alarms that replicate the natural sounds that a specific type of pet may make.

Further objects and advantages are to provide an electronic programmable pet care reminder timer providing audible and visual alarms that is, compact, simple to operate, inexpensive to manufacture, can be located in an easily and readily accessible location, and can be customized to provide specific reminders for administering pet care needs to a variety of different pets. Still further objects and advantages will become apparent from a consideration of the ensuing description.

### DRAWING FIGURES

In the drawings, closely related figures have the same number but different alphabetic suffixes.

FIG. 1 shows the preferred embodiment of the pet care reminder timer invention packaged in one of the many versions of pet theme related housings, an LCD visual event display and related programmable user interface buttons are illustrated.

FIG. 2 shows the rear view of the housing illustrating the audio enunciator and a magnetic attachment method which is one of several different types of attachment methods that can be used with the invention.

FIG. 3. shows the front view of an alternative embodiment of the invention using a plurality of LED's and corresponding labels for the visual alarm display, and the related programmable user interface buttons.

FIG. 3A. shows the front view of alternative embodiment utilizing a single LED and singular corresponding label for the visual alarm alert and related programmable user interface buttons.

FIG. 4. shows a ring clip fastener that allows the invention to be attached to a pet's collar.

FIG. 5. shows an electronic block diagram of the invention.

| | | | |
|---|---|---|---|
| 10 | decorative housing | 12 | LCD visual event display |
| 14 | user programmable interface | 16 | magnetic attachment fastener |
| | buttons | | |
| 18 | audio enunciator | 20 | label holder |
| 22 | label | 24 | LED visual event display |
| 26 | pet collar | 28 | collar attachment fastener clip |
| 30 | ring clip | 32 | buckle |
| 34 | ID tag ring | | |

### DESCRIPTION

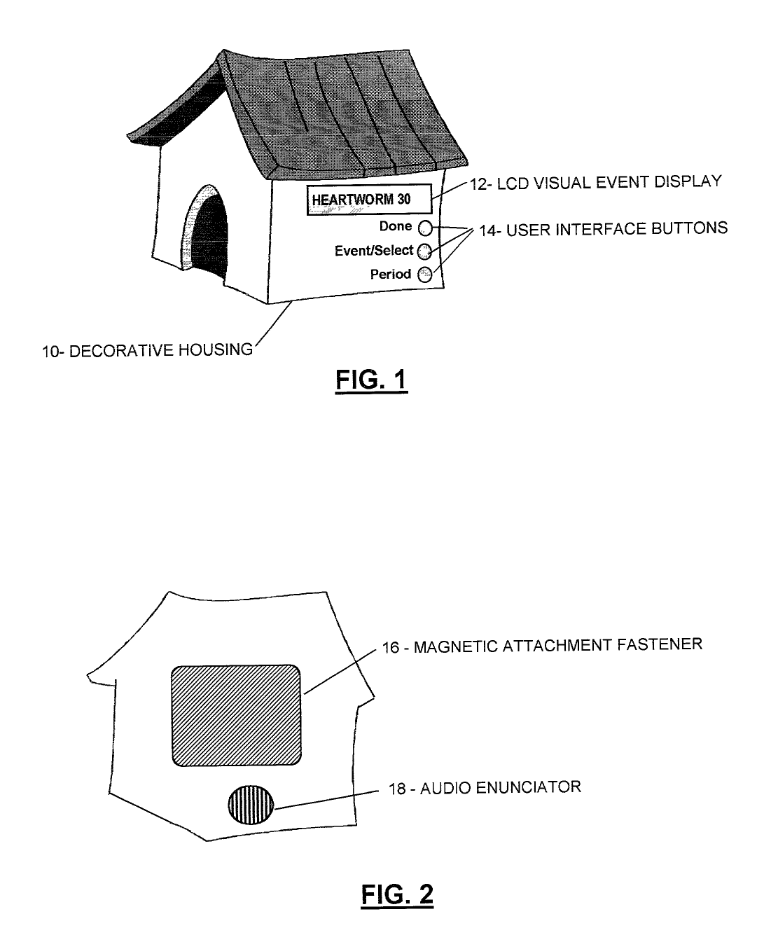

### FIGS. 1, 2, and 4—Preferred Embodiment

A typical embodiment of the present invention is illustrated in FIG. 1 (front view) and FIG. 2 (rear view). The programmable pet care reminder timer assembly consists of programmable electronic timing circuitry, power supply, visual indicator (12) audio enunciator (18) and user interface buttons. The invention may be packaged in a small decorative housing (10). The housing is appropriately and decoratively designed to correspond with the type of pet that the programmable reminder timer functions may be used for. Such decorative designs may include a molded doghouse for a dog, a yarn ball for a cat, aquarium for fish, etc. Decorative designs for specific pet applications are not limited to these examples.

The pet care reminder timer incorporates a means to temporarily affix it to an object conveniently located within the household where the pet is frequently administered care. As in the preferred embodiment of the invention, (FIG. 2) illustrates a magnetic attachment fastener (16) strip that is used to affix the pet timer reminder to metallic objects such as refrigerators, oven range doors or other metal appliances. Attachment methods are not limited to a magnetic strip and are described in the additional embodiments section of this patent application.

The front view (FIG. 1) of the preferred embodiment of the invention illustrates a visual display. In this embodiment of the invention, an LCD alpha/numeric display (12) provides text prompts to indicate the specific reminder to be administered for the pet's care. The display will provide a prompt instructing the user when to administer a specific medication, daily feeding, exercise, or maintenance, etc. An example of some typical reminders the display can indicate to the user indicate “Medication A”, “Medication B”, “Medication C”, “Feeding ”, “Heartworm”, “Flea”, “Walk”, Groom, Bath , etc. The display also provides the amount of elapsed time remaining until the reminder event is to be administered.

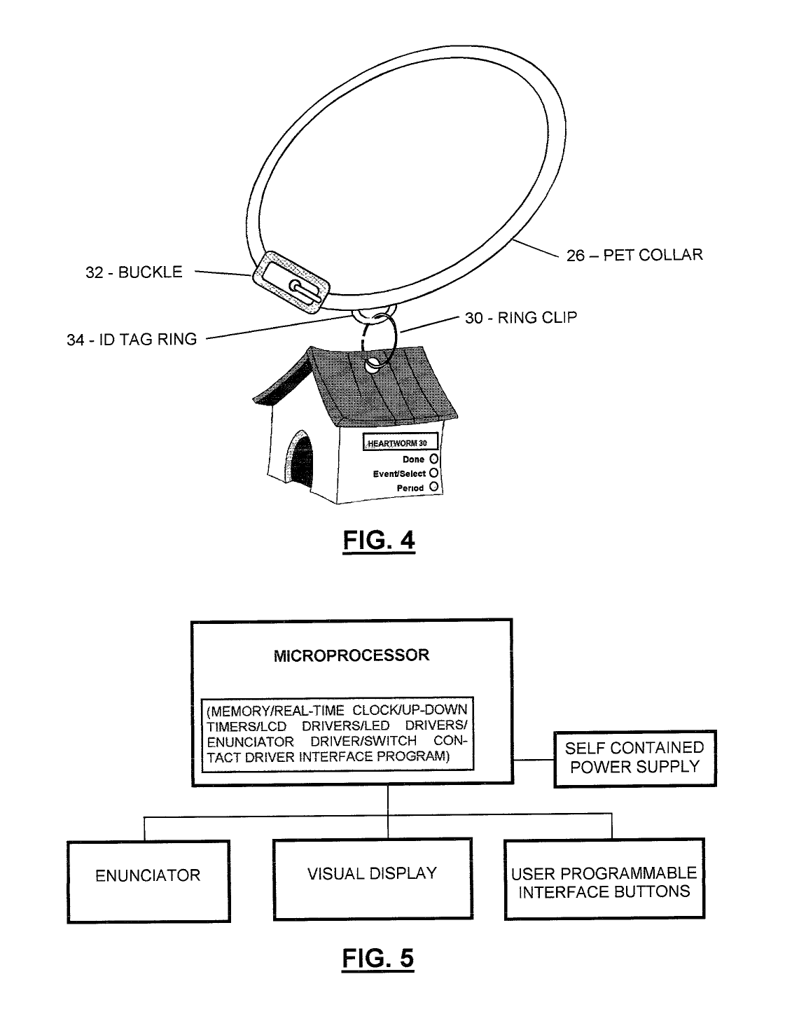

The circuitry illustrated in the block diagram (FIG. 4) of the preferred embodiment of the invention consists of a small microprocessor, (memory, real-time clock, count-down timer), miniature speaker or enunciator and associated electrical driver for interface to the LCD display and the user interface buttons. A small self-contained power source or battery supplies power to the circuitry. The microprocessor contains both a permanent and temporary memory to accomplish timing routines, provide text prompts and audio alert tones at the programmed intervals. The permanent memory contains a program for the processor to execute and keep track of multiple reminder event timings and perform other functions necessary for driving the LCD, miniature speaker or enunciator and the user interface buttons. A listing of all the available and specific reminders to be administered also resides in the permanent memory. By incorporating a list of reminders in permanent memory, specific events can easily be selected through the use of one user interface button.

The pet care reminder timer incorporates user interface buttons (FIG. 1) to provide for the control of reminder events and intervals. The user interface buttons (14) consists of buttons that are of momentary contact design to provide for the selecting, setting and resetting of specific timing events. Intervals for each event are programmable based upon hourly, daily and monthly occurrences. In the preferred embodiment of the invention a “Event/Select” button is used to scroll through a pre-selected menu of the type of event on the LCD display. Once the specific type of event is selected, a second “Period” button is used to program the interval period for the specific event. Timing for interval periods are selected by depressing the button once to correspond to a predetermined period of time. Subsequent depressing of the button allows for the timer interval to be increased. A third button “Done” is used to clear and reset the occurrence of an event and restart the timing of the event that is currently displayed on the LCD.

The pet care reminder timer incorporates an audio enunciator (18) to inform the user when an event has elapsed to administer pet care or maintenance. The audio enunciator's alert signal is presented and repeated periodically until the user resets the event. Another confirmation audio alert signal is presented to the user to notify them that they have cleared the event. The pet reminder timer's audio alert employs an audio circuit that recreates animal sounds that are representative of the specific pet the device is being used to administer care for. For example, a model designed for use with a dog could recreate a “barking” or “howling” sound, for cats, a “purring” or “meow” sound, for birds a “chirping” sound, etc. The animal sounds are recorded and generated electronically from circuitry residing in the device. In other embodiments of the preferred invention, the audio alert tone can also be simple bursts of single tone frequency to alert the user.

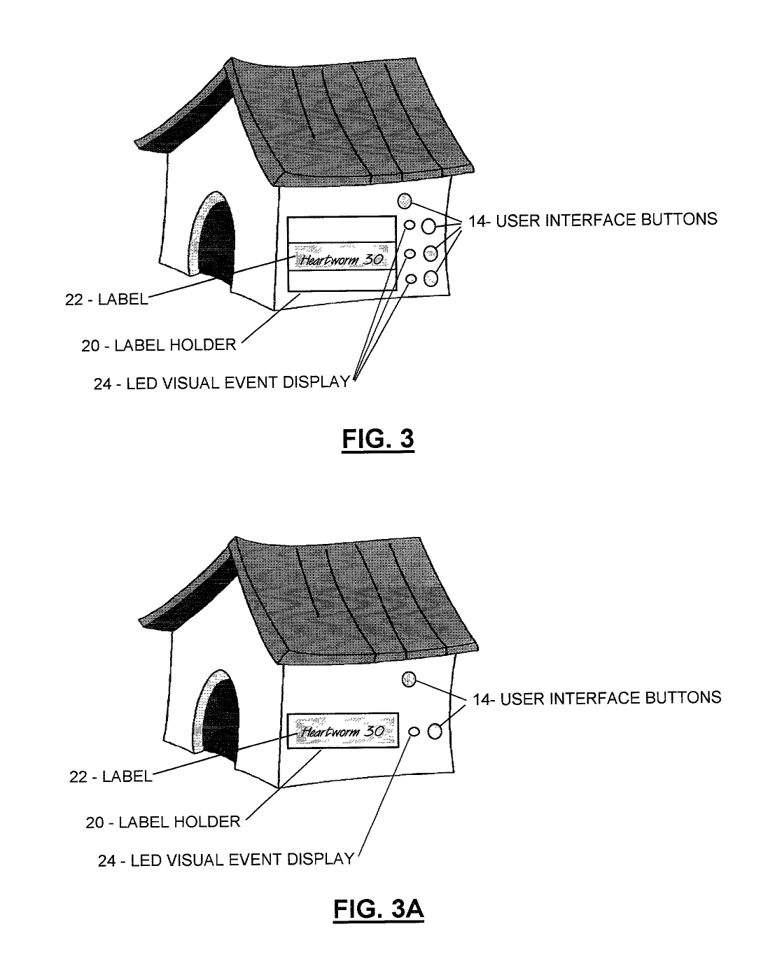

### FIGS. 3, 3A, And 4—Additional Embodiments

In additional embodiments of the invention, a suction cup, an adhesive backed tape, spring clip or adhesive backed Velcro hook & loop strip may be used to affix the timer to other non-metallic household objects such as mirrors, cupboards or walls. Further embodiments of these attachments means and methods are not limited to those examples cited.

In yet another embodiment of the invention, a strap, hook, clip (28) or other fastener can be used to attach the pet care timer reminder to a pet's collar or cage. Further embodiments of this application are not limited to timers that attach to a pet collar or pet cage with a fastener, however can include a collars or cages with the pet care reminder timer being integrated into the collar or cage itself.

### FIGS.—3 And 3A Alternative Embodiments

In an alternative embodiment of the invention (FIG. 3), the invention is comprised of an array of one or more LED's to serve as a display for each event that is being timed. Each LED corresponds to a specific reminder that is to be administered. A printed label (22) located adjacent to the LED visual event display (24) is used to indicate what specific item is to be administered to the pet. A single button adjacent to each LED is used to program the timing for the event, and resetting the occurrence of it. Timing for the reminder event is determined by depressing the user interface button a number of times to obtain an interval for timing. For example the pressing the button once may provide for one hour of timing. Pressing the button six times for six hours, etc. Dependent upon timing routines pre-assigned to each button, they may provide for hourly, daily or monthly intervals. Timing for the event commences upon the initial programming of the desired duration. In this described embodiment (FIG. 3) of the invention, one button is for selecting “hourly” events, another for “daily” events and the third for “monthly” events. The number of programmable events or their interval assignments of this described embodiment of the invention is not limited to the examples cited herein.

In the embodiment of the invention illustrated in (FIG. 3), a small pre-printed text label (22) indicating the specific reminder to be administered. The text labels are attached in a manner that allows them to be easily replaced or updated to reflect a new reminder that the user may want to administer. The label can be secured beneath a transparent label holder (20) that provides an opening to facilitate easy updating of it. In another embodiment this invention, the label can be constructed of a paper or Mylar type material with an adhesive backing. The adhesive backing would be of non-permanent properties to facilitate easy replacement or removal of the label directly to the front surface of the timer reminder housing.

Advantages

From the description above, a number of advantages of our programmable pet care reminder times becomes evident:

(a) The invention is specifically designed for pets, and reminders can be assigned to accommodate specific pet care for a particular type of pet, or a plurality of different types of pets.

(b) The small compact self contained design allows it to be placed or attached to an easily and readily accessible area where the pet owner can conveniently access it.

(c) The audible alarm may replicate the common sounds a specific type of pet creates, therefore being beneficial to the user to help distinguish what to type of care to administer when the several different types of pets are owned.

(d) The use of a LCD visual event display that indicates specifically what type of care to administer to the pet makes it easy and convenient for the pet owner.

(e) The use of a user definable label and simple LED visual event display to indicate specifically what type of care to administer to the pet makes it easy and convenient for the pet owner.

(f) The use of the most minimum amount of programmable user interface buttons to control and reset the timer makes it easy and convenient to operate for all pet owners.

(g) The novel packaging which provides for design themes applicable to a specific type of pet, helps the pet owner visually distinguish what type of care to administer when the user has several different types of pets.

(h) The ability to have a plurality of means to attach the invention to an easily and readily accessible objects provides the pet owner with many choices of locations within the owners house, or on a pet related objects, such as a collar or cage.

### Operation—FIGS. 1, 2, 3, 3A, 4, And 5

In the preferred embodiment of the invention (FIG. 1) the user installs or connects the power source battery. Upon power being applied, the microprocessor initiates its program and begins a default countdown timing cycle. The initial default timing timer is preset for a 30 day timing sequence for the administration of Heartworm and Flea medications. The microprocessor programs the LCD visual event display (12) window to say “Heartworm/Flea 30”. The “30” represents the number of days remaining until the Heartworm and or Flea medication is to be administered. The microprocessor causes the display continues to flash on and off until it detects the user has pressed the “Done” button. Upon the user depressing the button, the information in the LCD display window (12) changes to a constant steady state and two confirmation tones or sounds are generated. The change in state of the LCD display and the confirmation tones are used to inform the user that the timing cycle has been programmed. The microprocessor will then begin its countdown timing cycle for this event.

For each 24 hour interval that passes, the numeric display will decrement one count. For example, after 72 hours (3 days) has elapsed, the display will indicate “Heartworm 27”. This represents the amount of days remaining until the medication is to be administered. When the count in the LCD visual event display (12) reaches “00” the medication is to be administered. The audible alert tone will sound and the numeric display will begin to repeatedly flash on and off. The audible enunciator (18) and flashing display are to alert the user to administer the medication. After administering the medication the user presses the “Done” button to reset the timer and to begin countdown timing for the next 30 day medication cycle.

For other events that are to be timed, the user can depress the “Event/Select” button to scroll through a list of events they may want to administer to their pet. Pressing the button once causes the display window to indicate the next event. In this example the next event may indicate “Bath 15”. If the user determines to alter the Bath event timing period, the user repeatedly depresses the “Period” button until the desired amount of days appears in the LCD display window. The user then selects the “Done” button when the desired time interval is selected. The microprocessor will then begin its countdown timing cycle for this event.

The invention also permits countdown timing for multiple events that the user may want to administer within a 24 hour daily period. One to twenty-four daily reminders can be assigned and programmed for each event. Use of such daily reminders can be used for administering daily walks, feeding, and medications, etc. The user can press the Event/Select button until the event desired daily event appears in the LCD visual event display (24) window. In this example the next event may indicate “Medication C 06”. If the user determines to alter the Medication C event timing, the user repeatedly depresses the “Period” button until the desired amount of hours appears in the LCD display window. The use then selects the “Done” button when the desired time interval is selected. The microprocessor will then begin its countdown timing cycle for this event.

If two or more events occur that are to be administered, the pet care reminder timer will indicate the most recently occurring event. Upon selecting the “Done” button to clear the most recent event, the LCD display indicates the next event to be administered.

The user can check the time remaining for any programmed event that is scheduled, and any events that are not programmed. The “Select/Set button can be depressed to scroll through the list of available events. For each event that is not programmed, the LCD display will repeatedly flash on and off. For events that are programmed, the LCD will remain in a steady “on” state.

In the alternative embodiment of the invention illustrated in (FIG. 3) one or more LED's, corresponding labels, and Event/Set” and user interface buttons (14) are employed. The labels specify what type of event the timing period is to be used for. Several different models can be provided for the timing of multiple events.

In this model of the invention, (FIG. 3a) illustrates and describes the operation of a single programmable timer model. The user would print the event they wish to administer on a label (22). In this example the user would print “Heartworm/Flea” on the label and affix it adjacent to the LED indicator.

When power is first applied, the timer is preset for 30 days and flashes repeatedly indicating that the time has elapsed. If the user wishes to leave the timer preset for 30 days, the user momentarily depresses and releases the “Event/Set” button. The LED visual event display (24) will stop flashing to indicate to the user the timing cycle has been set. At any time during the countdown cycle, the user can check to see the remaining time by depressing the Event/Set button. The LED will flash a corresponding number of times for the time left remaining. When the countdown timer cycle has elapsed, the LED will begin to flash repeatedly indicating to the user to administer the Heartworm/Flea medication. After administering the medication, the user would depress the “Event/Set” button to begin the next countdown timing cycle.

The user can alter the preset 30 day timing cycle by depressing the “Program” button and simultaneously depressing the “Event/Set” button the number of times to correspond to the desired timing cycle. In this example pressing the “Event/Set” button 15 times would correspond to a 15 day cycle.

The operation and use of the invention in (FIG. 3) employing the multi-timer models is similar to that of the single timer model described previously. In the case of a 3 timer model, the first timer may be used for selecting monthly events, a second for weekly events, and a third for hourly events, etc.

Conclusion, Ramifications and Scope

Accordingly, the reader will see that the programmable pet care reminder timer of this invention is very beneficial to both young and elderly to ensure their pet's care needs are easily administered. The ability to for the electronic reminder to be used with virtually any type of pet, and to have it be specifically customized to specify what needs to be administered demonstrates it universality. Additionally, the invention will help reduce a pets care long term maintenance costs, by providing the owner with a scheduled regimen to ensure the pet is kept as healthy as possible. Furthermore, the programmable pet care reminder timer has the additional advantages in that

it can be attached to a myriad of locations using a variety of simple attachment means in which can be a magnet, strap, suction cup, Velcro or other simple fastener mechanism;

it is small, compact, and non-obtrusive and can be placed in easily and readily accessible locations and areas that a pet owner may frequent regularly;

it allows the user to select and customize the specific care needs of their pet, so that the pet owner can easily identify when and what the pet's needs are;

its decorative pet theme related packaging and unique audio alarm enunciator that replicates a pet's natural sounds makes the invention attractive to owners of pets and its novelty will help remind the pet owner to use the invention to ensure their pet is well taken care of;

it is simple to operate and easily programmed by any pet owner;

it helps promotes the well being of the pet and it's owner.

Although the description above contains many specificities, these should not be construed as limit the scope of the invention but as merely providing illustrations of some of the presently preferred embodiments of this invention. For example, the invention can be packaged in simple, circular, square, oval or other shapes, etc.; the attachment means can be specifically tailored to attach to or be integrated into common pet accessories such as collars, leashes, cages, or other pet related articles a pet owner may commonly use, etc.

Thus the scope of the invention should be determined by the appended claims and their legal equivalents, rather than by the examples given.

We claim:

1. A pet care timer comprising a case configured to mount in a location where a user will likely access it, with at least one timer, indicators showing the user the occurrence of an event, incorporating buttons or switches allowing the user to program and control the timer.

2. The invention of claim 1 with a fastener means to provide universal mounting of the timer to locations within a household.

3. The invention of claim 2 with a magnet, suction cup, compression clip, spring clip, Velcro or adhesive backed fastener, buckle, hook, split ring, key chain ring, etc.

4. The invention of claim 1 with a fastener means to provide a universal mounting of the timer to pet related accessories or objects.

5. The invention of claim 4 with a magnet, suction cup, compression clip, spring clip, Velcro or adhesive backed fastener, buckle, hook, split ring, key chain ring, etc.

6. The invention of claim 1 comprising an audible indicator to alert a pet owner.

7. The audible indicator of claim 6 comprising an enunciator that emits animal sounds.

8. The invention of claim 1 comprising a visual indicator to alert a pet owner.

9. The invention of claim 9 comprising at least one LED's.

10. The invention of claim 10 with user definable labels that can be situated adjacent to an LED indicator to specify what type of event is being timed.

11. The invention of claim 9 comprising an LCD display.

12. The invention of claim 1 comprising a memory for the storage of a pre-determined list of routine pet care or maintenance requirements.

13. The invention of claim 1 comprising a decoratively configured case.

14. The invention of claim 13 comprising a decoratively configured case that provides the pet owner the ability to visually distinguish the type of pet the timer is to be used with.

15. A pet care timer integrated into a pet collar comprising at least one timer, indicators showing the user the occurrence of an event, incorporating buttons or switches allowing the user to program and control the timer.
